(19) United States
(12) Patent Application Publication
(10) Pub. No.: US 2025/0245356 A1
(43) Pub. Date: Jul. 31, 2025

(54) INFORMATION PROCESSING APPARATUS, INFORMATION PROCESSING METHOD, AND COMPUTER READABLE RECORDING MEDIUM

(71) Applicant: NEC Corporation, Tokyo (JP)

(72) Inventors: Shota KIZUKURI, Tokyo (JP); Takahisa Yutoku, Tokyo (JP); Wataru Takahashi, Tokyo (JP); Shota Umeki, Tokyo (JP); Yoshihiko Koizumi, Tokyo (JP)

(73) Assignee: NEC Corporation, Tokyo (JP)

(21) Appl. No.: 19/002,986

(22) Filed: Dec. 27, 2024

(30) Foreign Application Priority Data
Jan. 30, 2024 (JP) 2024-012105

(51) Int. Cl. G06F 21/60; G06F 8/76; G06F 21/57

(52) U.S. Cl. CPC G06F 21/604; G06F 8/76; G06F 21/57

(57) ABSTRACT

An information processing apparatus presents a count of rules for which conversion processing by a tool is successful and a count of rules for which the conversion processing fails, the conversion processing being for converting rules written in a specific format that are for detecting a cyberattack into a format implementable in a system.

### CROSS-REFERENCE TO RELATED APPLICATIONS

This application is based upon and claims the benefit of priority from Japanese patent application No. 2024-012105, filed on Jan. 30, 2024, the disclosure of which is incorporated herein in its entirety by reference.

### BACKGROUND OF THE INVENTION

### 1. Field of the Invention

The present disclosure relates to an information processing apparatus and an information processing method that present information for achieving utilization of CTI (Cyber Threat Intelligence), and further relates to a program for realizing the apparatus and method.

### 2. Background Art

In recent years, a variety of computer systems have been proposed, in order to prevent cyberattacks that are becoming more complex and sophisticated (e.g., see Patent Document 1). Furthermore, utilization of CTI (Cyber Threat Intelligence) in such computer systems is attracting attention.

CTI refers to collecting, accumulating, and analyzing vast amounts of information relating to cyberattacks, such as opensource information, vulnerability information, malware analysis results, unauthorized IP information and unauthorized domain information, in an effort to utilize such information in security measures in response to the threat of cyberattacks. Also, intelligence is a military term indicating intelligence gathering or analysis.

In order to utilize CTI, it is important to rotate an intelligence cycle. The intelligence cycle is a series of processing from collection to consumption (implementation) of threat intelligence, and mainly consists of “collection”, “processing”, and “implementation”.

Specifically, first, as “collection” of threat intelligence, Sigma rules are initially collected. “Sigma” is a general-purpose signature format for describing log events in a relatable manner. Sigma rules are detection rules for detecting malicious files such as malware and are written in Sigma.

Next, as “processing”, processing for converting the collected Sigma rules into detection rules implementable in the system is performed. Also, this conversion processing is performed automatically using existing tools. Sigma rules are updated daily and thus converting updated Sigma rules into detection rules is extremely important.

The detection rules converted from Sigma rules are then implemented in the system.

Such “collection”, “processing”, and “implementation” are executed periodically.
Patent Document 1: Japanese Patent Laid-Open Publication No. 2023-023000

Incidentally, given that collected Sigma rules are updated daily, as mentioned above, automatic conversion utilizing existing tools may not be possible. In this case, an administrator of the system performs conversion manually, but the administrator has no way of knowing the automation efficiency of the conversion processing. Thus, with the conventional intelligence cycle, there is a problem in that the conversion processing may be delayed, and, as a result, the efficiency of the entire intelligence cycle cannot be improved.

### SUMMARY OF THE INVENTION

An example object of the present disclosure is to improve the efficiency of the CTI intelligence cycle.

In order to achieve the above-described object, an information processing apparatus includes:
an information presentation means for presenting a count of rules for which conversion processing by a tool is successful and a count of rules for which the conversion processing fails, the conversion processing being for converting rules written in a specific format that are for detecting a cyberattack into a format implementable in a system.

In order to achieve the above-described object, an information processing method includes:
presenting a count of rules for which conversion processing by a tool is successful and a count of rules for which the conversion processing fails, the conversion processing being for converting rules written in a specific format that are for detecting a cyberattack into a format implementable in a system.

In order to achieve the above-described object, a computer readable recording medium according to an example aspect of the invention is a computer readable recording medium that includes recorded thereon a program,
the program including instructions that cause the computer to carry out:
presenting a count of rules for which conversion processing by a tool is successful and a count of rules for which the conversion processing fails, the conversion processing being for converting rules written in a specific format that are for detecting a cyberattack into a format implementable in a system.

As described above, according to the invention, it is possible to improve the efficiency of the CTI intelligence cycle.

### BRIEF DESCRIPTION OF THE DRAWINGS

FIG. 1 is a block diagram illustrating an example schematic configuration of the information processing apparatus.

FIG. 2 is a configuration diagram illustrating a configuration of the information processing apparatus in more detail.

FIG. 3 is a diagram illustrating specific examples of processing performed by the information presentation unit, the rule collection unit, the first conversion unit, the second conversion unit, and the index calculation unit.

FIG. 4 is a diagram illustrating a specific example of the case where conversion processing by the first conversion unit fails.

FIG. 5 is a diagram illustrating a specific example of data input to the generative AI serving as the second conversion unit and data output from the generative AI.

FIG. 6 is a diagram illustrating a specific example of the case where conversion processing by the second conversion unit fails.

FIG. 7 is a diagram illustrating a specific example of information presented by the information presentation unit.

FIG. 8 is a flow diagram illustrating an example of operations by the information processing apparatus.

FIG. 9 is a diagram illustrating an example of the information processing apparatus.

FIG. 10 is a diagram illustrating an example of processing in a malware information sharing platform.

FIG. 11 is a block diagram illustrating an example of a computer that realizes the information processing apparatus.

### EXAMPLE EMBODIMENT

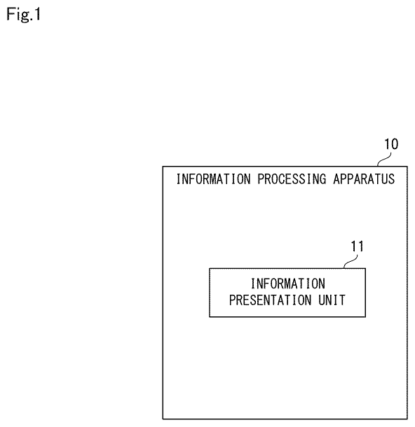

Hereinafter, an information processing apparatus, an information processing method, and a program of an example embodiment will be described with reference to FIGS. 1 to 10.

### [Apparatus Configuration]

Initially, a schematic configuration of the information processing apparatus will be described using FIG. 1. FIG. 1 is a block diagram illustrating an example schematic configuration of the information processing apparatus.

An information processing apparatus 10 shown in FIG. 1 is an apparatus for presenting information necessary in order to execute an CTI intelligence cycle to an administrator of the system. As illustrated in FIG. 1, the information processing apparatus 10 is provided with an information presentation unit 11.

The information presentation unit 11 presents a count of rules for detecting cyberattacks written in a specific format for which conversion processing by a tool is successful and a count of rules for which conversion processing by the tool fails. Here, the tool is a tool for converting the rules into a format implementable in a target system.

In this way, the information processing apparatus 10 is able to present a count of rules automatically converted utilizing the tool and a count of rules not automatically converted to the administrator of the system. Thus, the administrator of the system is able to smoothly rotate the intelligence cycle, and the efficiency of the CTI intelligence cycle is improved.

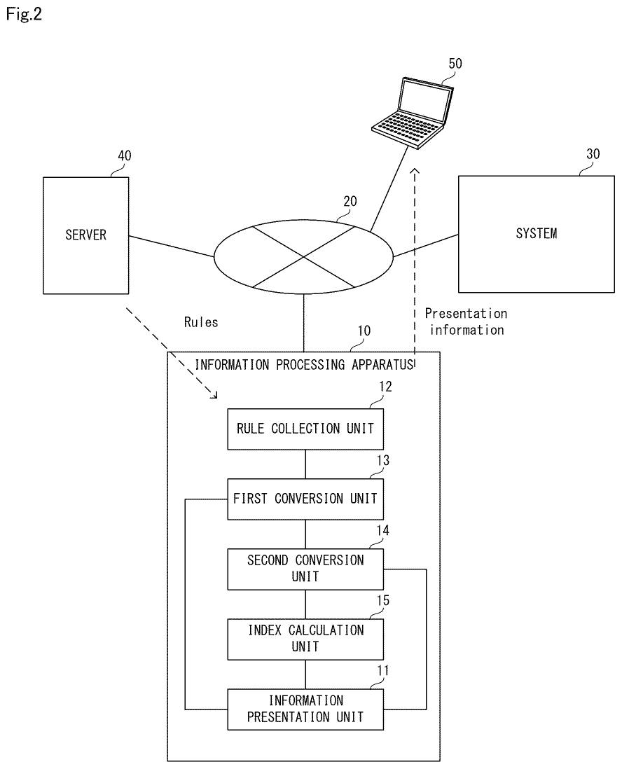

Next, the configuration and functions of the information processing apparatus 10 will be described in detail, using FIG. 2. FIG. 2 is a configuration diagram illustrating a configuration of the information processing apparatus in more detail.

As illustrated in FIG. 2, in addition to the information presentation unit 11 described above, the information processing apparatus 10 is provided with a rule collection unit 12, a first conversion unit 13, a second conversion unit 14, and an index calculation unit 15. Also, the information processing apparatus 10 is connected, via a network 20, to a system 30 that is subject to the intelligence cycle, a server 40 that administers the rules, and a terminal device 50 of the administrator of the system 30.

The system 30 is a computer system constituted by a plurality of computers. The system 30 is not particularly limited but is principally a system that is subject to a cyberattack. Also, examples of the format implementable in the system 30 include a query format that can be used with M365D (Microsoft 365 Defender). M365D is an enterprise security service (see Reference 1).
Reference 1:

https://learn.microsoft.com/ja-jp/microsoft-365/security/defender/microsoft-365-defender?view=o365-worldwide

The server 40 stores rules written in a specific format that are for detecting a cyberattack. Examples of rules written in a specific format that are for detecting a cyberattack include the above-described Sigma rules. The server 40 updates the stored rules (Sigma rules) as necessary.

The rule collection unit 12 accesses the server 40 and collects stored rules. The collection of rules by the rule collection unit 12 is executed periodically or in response to an instruction from the administrator.

The first conversion unit 13 uses a tool (hereinafter referred to as “the first tool”) to convert rules collected by the rule collection unit 12 into a format implementable in the system 30. Specifically, the tool includes a tool for converting Sigma rules into detection rules (M365 queries) implementable in the system, such as a converter written in Python, for example.

The second conversion unit 14 uses a tool (hereinafter referred to as “the second tool”) other than the first tool that is used by the first conversion unit 13. The second conversion unit 14 uses the second tool to convert rules for which conversion processing by the first conversion unit 13 fails into a format implementable in the system 30.

Specifically, the second conversion unit 14 is able to use generative AI as the second tool. In this case, the second conversion unit 14 inputs rules for which conversion processing by the first conversion unit 13 fails into the generative AI and executes conversion processing.

With regard to rules for which conversion processing by both the first conversion unit 13 and the second conversion unit 14 fails, the administrator manually converts these rules into a format implementable in the system 30. In order to show the administrator how successful the conversion processing by the first conversion tool and the second conversion tool is, the index calculation unit 15 calculates an index indicating the degree of reduction in this manual conversion processing.

In addition to the count of rules for which conversion processing by the first tool is successful, the information presentation unit 11 presents a count of rules for which conversion processing by the second tool is successful, and a count of rules for which conversion processing by the second tool is not successful. The information presentation unit 11 is also able to present a count of rules converted manually as the count of rules for which conversion processing by the second tool is not successful. Furthermore, the information presentation unit 11 is also able to present an index indicating the degree of reduction in the above-mentioned manual conversion processing.

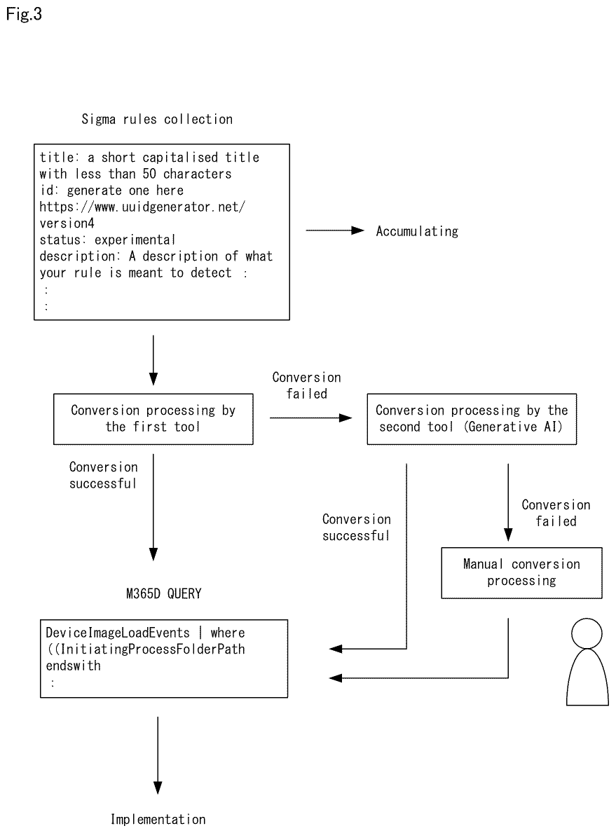

Next, the processing by the units of the information processing apparatus 10 will be described in detail, using FIGS. 3 to 7. FIG. 3 is a diagram illustrating specific examples of processing performed by the information presentation unit, the rule collection unit, the first conversion unit, the second conversion unit, and the index calculation unit.

As shown in the example of FIG. 3, the rule collection unit 12 accesses the server 40 and collects Sigma rules. The collected Sigma rules are accumulated by the information processing apparatus 10.

The first conversion unit 13 executes conversion processing on the collected Sigma rules, using the first tool. The rules for which conversion processing by the first tool is successful become M365D queries. On the other hand, the rules for which conversion processing by the first tool fails are sent to the second conversion unit 14.

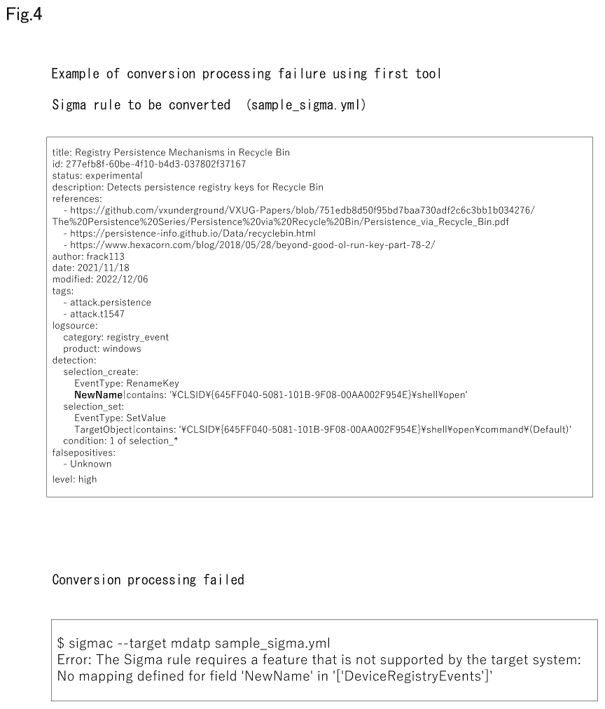

FIG. 4 is a diagram illustrating a specific example of the case where conversion processing by the first conversion unit fails. The example in FIG. 4 shows the case where the conversion processing fails due to an error in the way a Sigma rule is written. Specifically, a field called NewName is used in the Sigma rule, but a corresponding field does not exist in the fields that can be used with M365D, and thus the conversion processing fails.

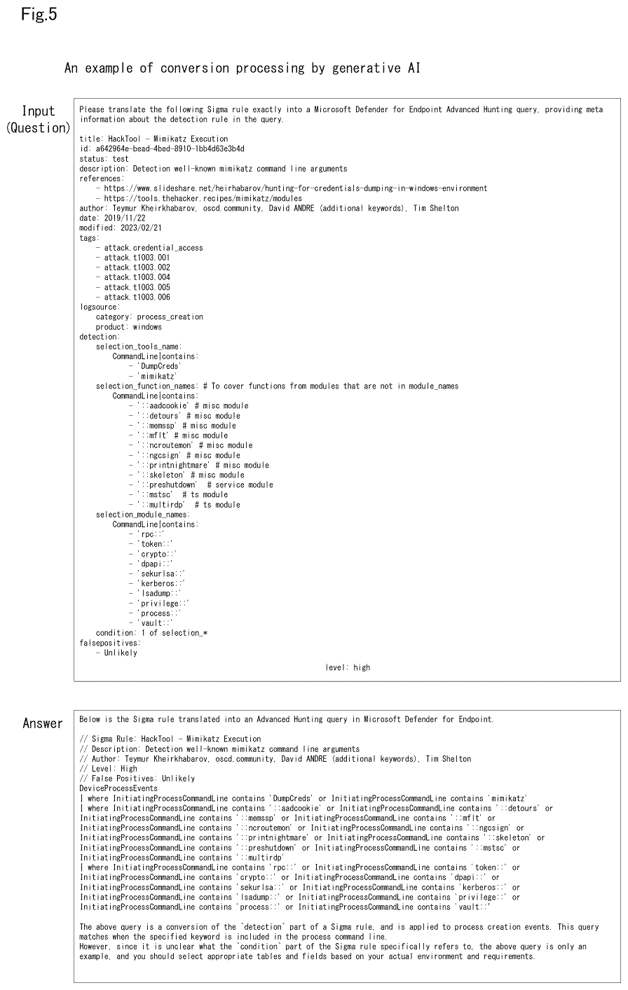

The second conversion unit 14 executes conversion processing on rules for which conversion processing by the first tool fails, using generative AI as the second tool. FIG. 5 is a diagram illustrating a specific example of data input to the generative AI serving as the second conversion unit and data output from the generative AI. As illustrated in FIG. 5, the second conversion unit 14 inputs a rule for which conversion processing by the first tool fails to the generation AI as a query. A rule that has undergone conversion processing is thereby output as an answer.

The rules for which conversion processing by the generative AI serving as the second unit is successful become M365D queries. On the other hand, the rules for which conversion processing by the second tool fails are sent to an external terminal device.

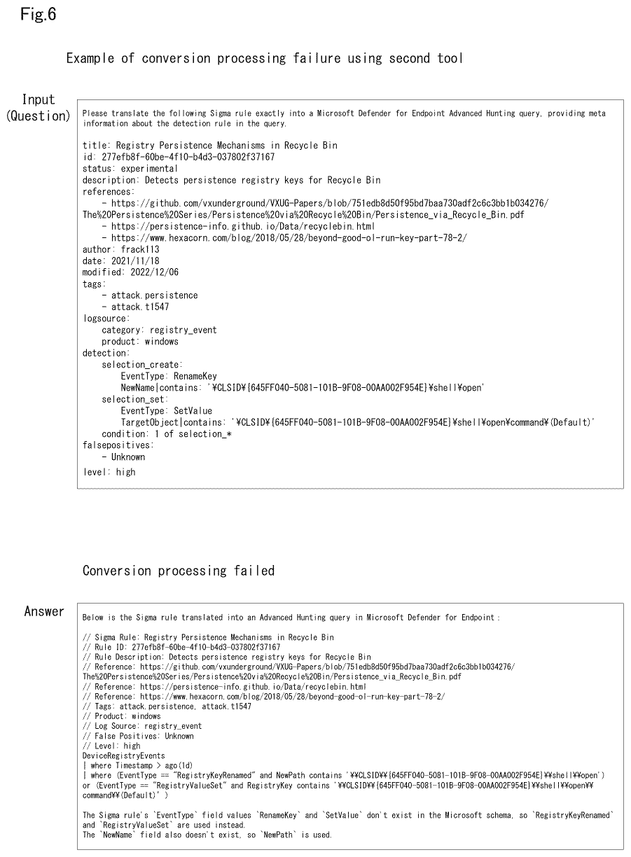

FIG. 6 is a diagram illustrating a specific example of the case where conversion processing by the second conversion unit fails. If there is an error in a Sigma rule, the generative AI is able to correct the error and output an answer. However, there may be an error in the corrected content and the conversion processing may fail as a result. In the example of FIG. 6, the generative AI detects that M365D does not have a field corresponding to NewName and changes NewName to a field called NewPath. In actuality, however, there is also no field corresponding to NewPath in the fields that can be used with M365D, and thus the conversion processing fails.

In the external terminal device, a person-in-charge (specialist) who has the skills to perform conversion processing manually executes conversion processing on the rule for which conversion processing by the second tool fails. The rule for which conversion processing by the second tool fails also thereby becomes an M365D query. The M365D queries converted as described above are ultimately implemented in the system 30.

The index calculation unit 15 calculates an index (hereinafter referred to as “efficiency index” or “man-hour reduction rate”) indicating the degree of reduction in this manual conversion processing. Specifically, the index calculation unit 15 uses the following formula 1 to calculate the efficiency index.

Efficiency index[%]=count of successfully converted rules/total count of collected rules×100 (Formula 1)

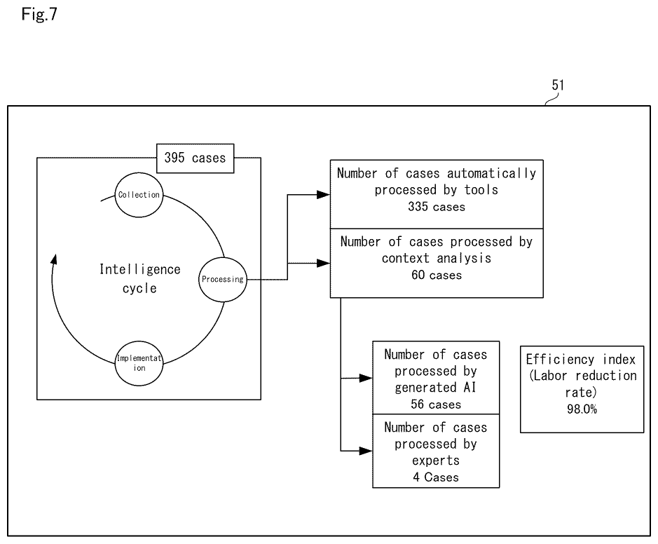

When the processing by the rule collection unit 12, the first conversion unit 13, the second conversion unit 14, and the index calculation unit 15 ends, the information presentation unit 11 creates data for presenting the calculated values and transmits the created data to the terminal device 50 of the administrator of the system 30. A screen 51 shown in FIG. 7 is thereby displayed on a display of the terminal device 50. FIG. 7 is a diagram illustrating a specific example of information presented by the information presentation unit.

### [Apparatus Operations]

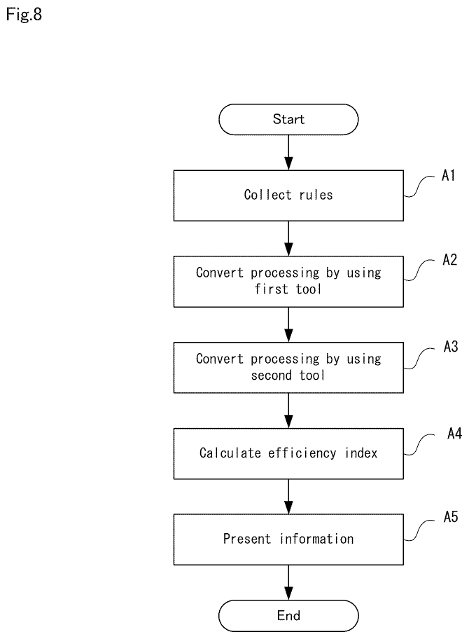

Next, operations of the information processing apparatus 10 will be described using FIG. 8. FIG. 8 is a flow diagram illustrating an example of operations by the information processing apparatus. In the following description, FIGS. 1 to 7 will be referred to as appropriate. Also, in the example embodiment, an information processing method is implemented by operating the information processing apparatus 10. Therefore, in the example embodiment, the following description of operations of the information processing apparatus 10 is given in place of description of the information processing method.

As illustrated in FIG. 8, first, the rule collection unit 12 collects rules written in a specific format that are for detecting a cyberattack (step A1). Specifically, in step A1, the rule collection unit 12 accesses the server 40 and collects stored Sigma rules.

Next, the first conversion unit 13 uses the first tool to convert the rules collected in step A1 by the rule collection unit 12 into a format implementable in the system 30 (step A2). Specifically, in step A2, the first conversion unit 13 converts the Sigma rules into M365 queries.

Next, the second conversion unit 14 specifies rules for which the conversion processing in step A2 fails, and uses the second tool to convert the specified rules into a format implementable in the system 30 (step A3).

Specifically, the second conversion unit 14 inputs rules for which the conversion processing in step A2 fails to a generative AI serving as the second tool and executes conversion processing. Also, when the conversion processing ends, the second conversion unit 14 notifies rules for which the conversion processing in step A3 fails to the terminal device 50 of the administrator.

Next, the index calculation unit 15 specifies a count of rules for which the conversion processing fails in step A3 and calculates an efficiency index, using the specified count of rules and a count of rules collected in step A1 (step A4).

Next, the information presentation unit 11 presents a count of rules for which conversion processing by the first tool in step A2 is successful, a count of rules for which conversion processing by the second tool in step A3 is successful, and the count of rules for which conversion processing by the second tool in step A3 is not successful (step A5).

Specifically, the information presentation unit 11 derives the various counts of rules, creates data for presenting the derived counts of rules, and transmits the created data to the terminal device 50 of the administrator of the system 30. The screen 51 shown in FIG. 7 is thereby displayed on the display of the terminal device 50.

### Effects of Embodiment

In the example embodiment as described above, the count of rules automatically converted utilizing a tool, the count of rules automatically converted by generative AI, and the count of rules not automatically converted are presented to the administrator of the system 30. The administrator is also presented with an efficiency index as an indicator of the degree of reduction in the conversion processing that is performed manually. According to the example embodiment, the administrator of the system can thus smoothly rotate the intelligence cycle, and the efficiency of the CTI intelligence cycle is improved.

### [Program]

The program in the example embodiment need only be a program that causes a computer to execute steps A1 to A5 shown in FIG. 8. The information processing apparatus 10 and the information processing method can be realized, by this program being installed on a computer and executed. In this case, a processor of the computer performs processing while functioning as the information presentation unit 11, the rule collection unit 12, the first conversion unit 13, the second conversion unit 14, and the index calculation unit 15. Examples of the computer include a general-purpose PC as well as a smartphone and a tablet-type terminal device.

The program in the example embodiment may also be executed by a computer system constructed from a plurality of computers. In this case, for example, each computer may function as one of the information presentation unit 11, the rule collection unit 12, the first conversion unit 13, the second conversion unit 14, and the index calculation unit 15.

### APPLICATION EXAMPLES

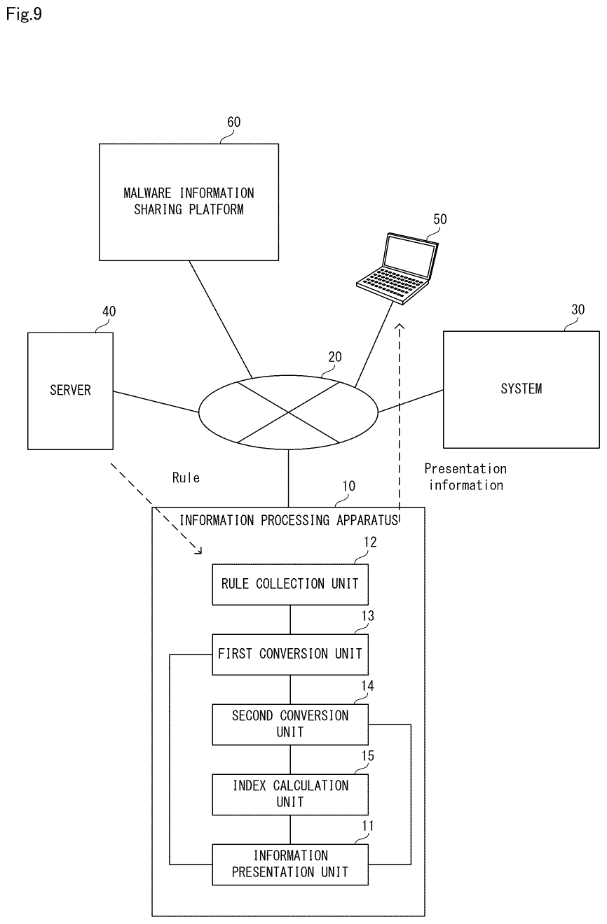

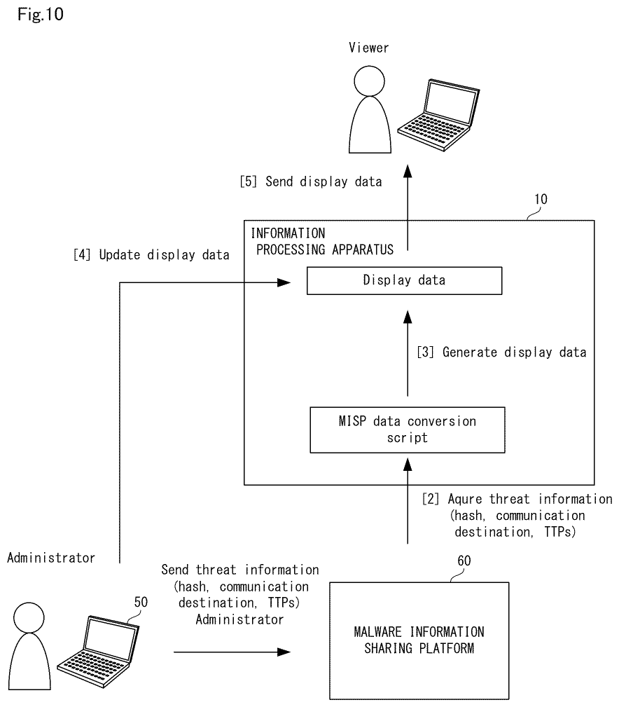

Next, examples of the information processing apparatus 10 will be described using FIGS. 9 and 10. FIG. 9 is a diagram illustrating an example of the information processing apparatus. FIG. 10 is a diagram illustrating an example of processing in a malware information sharing platform.

As illustrated in FIG. 9, the information processing apparatus 10 is connected to a malware information sharing platform (MISP) 60 via the network 20. The information processing apparatus 10 is able to cooperate with the malware information sharing platform 60.

The malware information sharing platform 60 is an opensource platform for sharing cybersecurity-related information. Incident response teams (CSIRTs), government agencies, enterprises, and cybersecurity communities use the malware information sharing platform 60 in order to collect, organize, and share malware-related information, such as indicators of compromise (IoCs), tactics, techniques, and procedures (TTPs).

Cooperation between the information processing apparatus 10 and the malware information sharing platform 60 will now be described, using FIG. 10. First, the administrator of the system 30 transmits threat information relating to cyberattacks to the malware information sharing platform 60, via the terminal device 50. The malware information sharing platform 60 registers the threat information transmitted thereto.

Next, the information processing apparatus 10 acquires threat information registered in the malware information sharing platform 60, using a MISP data conversion script. Furthermore, the information processing apparatus 10 converts the acquired threat information into display data. Specifically, the information processing apparatus 10 converts the acquired threat information into CSV data.

Also, the administrator is able to update the contents of display data converted by the information processing apparatus 10 as appropriate. Thereafter, the information processing apparatus 10 transmits display data to the terminal device of a viewer. The viewer is thereby able to check the registered threat information on a display of the terminal device.

In this way, the information processing apparatus 10, in the case of cooperating with the malware information sharing platform 60, is able to convert threat information registered therein into display data that is displayable on a terminal device, and transmit the resultant display data to the terminal device.

### [Physical Configuration]

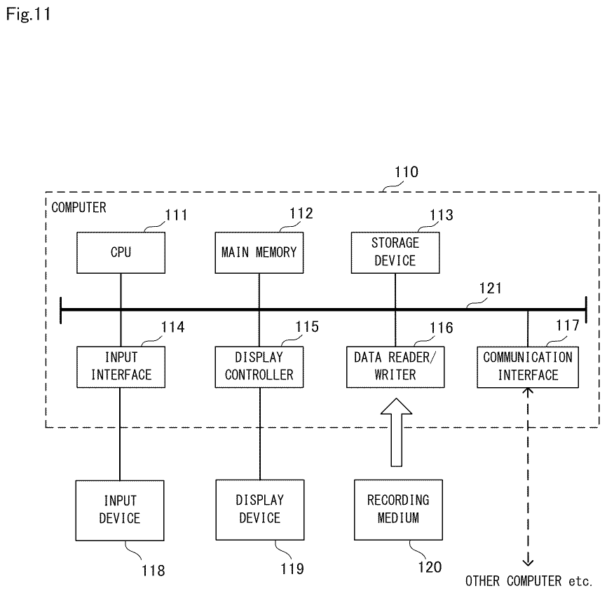

Here, a computer that realizes the information processing apparatus 10 by executing the program will be described with reference to FIG. 11. FIG. 11 is a block diagram illustrating an example of a computer that realizes the information processing apparatus.

As illustrated in FIG. 11, a computer 110 includes a CPU 111, a main memory 112, a storage device 113, an input interface 114, a display controller 115, a data reader/writer 116, and a communication interface 117. These units are connected via a bus 121 so as to be able to perform data communication with each other.

the computer 110 may include a GPU (Graphics Processing Unit) or a FPGA (Field-Programmable Gate Array) in addition to the CPU 111 or instead of the CPU 111. In this case, the GPU or the FPGA may execute the program.

The CPU 111 loads programs (codes) according to the present example embodiment stored in the storage device 113 to the main memory 112, and executes the programs in a predetermined order to perform various kinds of calculations. The main memory 112 is typically a volatile storage device such as a DRAM (Dynamic Random Access Memory).

Also, the program according to the present example embodiment is provided in the state of being stored in a computer-readable recording medium 120. Note that programs according to the present example embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and an input device 118 such as a keyboard or a mouse. The display controller 115 is connected to a display device 119 and controls the display of the display device 119.

The data reader/writer 116 mediates data transmission between the CPU 111 and the recording medium 120, reads out programs from the recording medium 120, and writes the results of processing performed by the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

Note that the information processing apparatus 10 can also be realized by using hardware (for example, electronic circuits) corresponding to the units, in place of a computer that has programs installed therein. Furthermore, a configuration may also be adopted in which a portion of the information processing apparatus 10 is realized by programs, and the remaining portion of the information processing apparatus 10 is realized by hardware. In the example embodiment, the computer is not limited to the computer illustrated in FIG. 11.

One or all of the above-described example embodiments can be expressed as, but are not limited to, Supplementary Note 1 to Supplementary Note 12 described below.

### (Supplementary Note 1)

An information processing apparatus comprising:
an information presentation means for presenting a count of rules for which conversion processing by a tool is successful and a count of rules for which the conversion processing fails, the conversion processing being for converting rules written in a specific format that are for detecting a cyberattack into a format implementable in a system.

### (Supplementary Note 2)

The information processing apparatus according to supplementary note 1,
wherein the information presentation means presents a count of rules for which conversion processing by a second tool different from the tool is successful and a count of rules for which conversion processing by the second tool is not successful, out of the rules for which the conversion processing by the tool fails, and
the second tool is a tool for converting the rules into the format.

### (Supplementary Note 3)

The information processing apparatus according to supplementary note 2, further comprising:
a rule collection means for collecting the rules;
a first conversion means for converting the rules into the format using the tool; and
a second conversion means for inputting rules for which the conversion processing by the tool fails into a generative AI serving as the second tool and converting the input rules into the format.

### (Supplementary Note 4)

The information processing apparatus according to supplementary note 1,
wherein the information presentation means further presents an index indicating a degree of reduction in the conversion processing of the rules that is performed manually.

### (Supplementary Note 5)

An information processing method comprising:
presenting a count of rules for which conversion processing by a tool is successful and a count of rules for which the conversion processing fails, the conversion processing being for converting rules written in a specific format that are for detecting a cyberattack into a format implementable in a system.

### (Supplementary Note 6)

The information processing method according to supplementary note 5, further comprising:
presenting a count of rules for which conversion processing by a second tool different from the tool is successful and a count of rules for which conversion processing by the second tool is not successful, out of the rules for which the conversion processing by the tool fails,
wherein the second tool is a tool for converting the rules into the format.

### (Supplementary Note 7)

The information processing method according to supplementary note 6, further comprising:
collecting the rules;
converting the rules into the format using the tool; and
inputting rules for which the conversion processing by the tool fails into a generative AI serving as the second tool and converting the input rules into the format.

### (Supplementary Note 8)

The information processing method according to supplementary note 5, further comprising:
presenting an index indicating a degree of reduction in the conversion processing of the rules that is performed manually.

### (Supplementary Note 9)

A computer-readable recording medium that includes a program including instructions recorded thereon, the instructions causing a computer to carry out:
presenting a count of rules for which conversion processing by a tool is successful and a count of rules for which the conversion processing fails, the conversion processing being for converting rules written in a specific format that are for detecting a cyberattack into a format implementable in a system.

### (Supplementary Note 10)

The computer-readable recording medium according to supplementary note 9, further the program including instructions that cause a computer to carry out:
presenting a count of rules for which conversion processing by a second tool different from the tool is successful and a count of rules for which conversion processing by the second tool is not successful, out of the rules for which the conversion processing by the tool fails,
wherein the second tool is a tool for converting the rules into the format.

### (Supplementary Note 11)

The computer-readable recording medium according to supplementary note 10, further the program including instructions that cause a computer to carry out:
collecting the rules;
converting the rules into the format using the tool; and
inputting rules for which the conversion processing by the tool fails into a generative AI serving as the second tool and converting the input rules into the format.

### (Supplementary Note 12)

The computer-readable recording medium according to supplementary note 9, further the program including instructions that cause a computer to carry out:
presenting an index indicating a degree of reduction in the conversion processing of the rules that is performed manually.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to improve the efficiency of the CTI intelligence cycle. The present disclosure is useful for a several system concerned to cybersecurity.

### REFERENCE SIGNS LIST

10 Information processing apparatus
11 Information presentation unit
12 Rule collection unit
13 First conversion unit
14 Second conversion unit
15 Index calculation unit
20 Network
30 System
40 Server
50 Terminal device
60 Malware information sharing platform
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
present a count of rules for which conversion processing by a tool is successful and a count of rules for which the conversion processing fails, the conversion processing being for converting rules written in a specific format that are for detecting a cyberattack into a format implementable in a system.

2. The information processing apparatus according to claim 1,
wherein the one or more processors further presents a count of rules for which conversion processing by a second tool different from the tool is successful and a count of rules for which conversion processing by the second tool is not successful, out of the rules for which the conversion processing by the tool fails, and
the second tool is a tool for converting the rules into the format.

3. The information processing apparatus according to claim 2, further comprising:
wherein the one or more processors further;
collect the rules;
convert the rules into the format using the tool; and
input rules for which the conversion processing by the tool fails into a generative AI serving as the second tool and converting the input rules into the format.

4. The information processing apparatus according to claim 1,
wherein the one or more processors further presents an index indicating a degree of reduction in the conversion processing of the rules that is performed manually.

5. An information processing method comprising:
presenting a count of rules for which conversion processing by a tool is successful and a count of rules for which the conversion processing fails, the conversion processing being for converting rules written in a specific format that are for detecting a cyberattack into a format implementable in a system.

6. The information processing method according to claim 5, further comprising:
presenting a count of rules for which conversion processing by a second tool different from the tool is successful and a count of rules for which conversion processing by the second tool is not successful, out of the rules for which the conversion processing by the tool fails,
wherein the second tool is a tool for converting the rules into the format.

7. The information processing method according to claim 6, further comprising:
collecting the rules;
converting the rules into the format using the tool; and
inputting rules for which the conversion processing by the tool fails into a generative AI serving as the second tool and converting the input rules into the format.

8. The information processing method according to claim 5, further comprising:
presenting an index indicating a degree of reduction in the conversion processing of the rules that is performed manually.

9. A non-transitory computer-readable recording medium that includes a program including instructions recorded thereon, the instructions causing a computer to carry out:
presenting a count of rules for which conversion processing by a tool is successful and a count of rules for which the conversion processing fails, the conversion processing being for converting rules written in a specific format that are for detecting a cyberattack into a format implementable in a system.

10. The non-transitory computer-readable according to claim 9, further the program including instructions that cause a computer to carry out:
presenting a count of rules for which conversion processing by a second tool different from the tool is successful and a count of rules for which conversion processing by the second tool is not successful, out of the rules for which the conversion processing by the tool fails,
wherein the second tool is a tool for converting the rules into the format.

11. The non-transitory computer-readable according to claim 10, further the program including instructions that cause a computer to carry out:
collecting the rules;
converting the rules into the format using the tool; and
inputting rules for which the conversion processing by the tool fails into a generative AI serving as the second tool and converting the input rules into the format.

12. The non-transitory computer-readable according to claim 9, further the program including instructions that cause a computer to carry out:
presenting an index indicating a degree of reduction in the conversion processing of the rules that is performed manually.
